(19) United States
(12) Patent Application Publication
(10) Pub. No.: US 2020/0125087 A1
(43) Pub. Date: Apr. 23, 2020

(54) VIRTUAL WALL SYSTEM FOR ROBOT

(71) Applicant: SHENZHEN LDROBOT CO., LTD., Guangdong (CN)

(72) Inventor: You WU, Guangdong (CN)

(21) Appl. No.: 16/605,717

(22) PCT Filed: Apr. 26, 2018
(86) PCT No.: PCT/CN2018/084582

§ 371 Date: Oct. 16, 2019

(30) Foreign Application Priority Data
Apr. 28, 2017 (CN) 201710295958.1

(51) Int. Cl. G05D 1/00; G05D 1/02; G05B 19/19; B25J 9/16; G01C 21/20

(52) U.S. Cl. CPC G05D 1/0044; G05D 1/0238; G05B 19/19; G05D 2201/0203; G01C 21/206; G05B 2219/40122; B25J 9/1664

(57) ABSTRACT

A virtual wall system for a robot includes: a movement device, configured to control a robot to move; a first electronic map, configured to describe information on environment where the robot is located; a virtual wall module, configured to form a virtual wall to divide the first electronic map into zones; a storage device, configured to store the first electronic map of the environment where the robot is located.

### CROSS-REFERENCES TO RELATED APPLICATIONS

This application is a National Stage of PCT Application PCT/CN2018/084582 filed on Apr. 26, 2018, which claims priority to Chinese Patent Application Ser. No. 201710295958.1, filed on Apr. 28, 2017, entitled “a virtual wall system for a robot”, the entire contents each of which are hereby incorporated in this application by reference.

### TECHNICAL FIELD

This application involves in the technical field of robot manufacture, particularly in a virtual wall system for a robot.

### BACKGROUND

With the advancement of technology, robots, especially cleaning robots, not only are used in large-scale industries, but also work in the home of ordinary people. However, the robots staying at home often move to various places, which may cause trouble for family life, so a virtual wall is needed to limit the movement of the robots.

In related technologies, the virtual wall configured for the cleaning robots or the mobile robots are often implemented by hardware, such as an infrared wall or a magnetic strip. These virtual wall generators can only generate virtual walls with a straight line, a single shape, and limited length, and they are high-cost, and relevant sensing modules must be installed on both the robots and the virtual walls. In actual operations and use processes, different virtual wall generators have to be arranged by manual placement at each time, which is complicated to operate.

### SUMMARY

This application is aimed to solve, to some extent, at least one of the technical problems in the relevant technologies mentioned above.

Therefore, the aim of this application is to provide a virtual wall system for a robot. The virtual wall system for a robot substitutes functions of a virtual wall generated by hardware. The method for directly drawing a virtual wall on an electronic map facilitates a user to arrange a virtual wall and reduces the cost of manufacturing robots.

In order to achieve the above-mentioned purposes, an aspect of this application discloses a virtual wall system for robot, which includes: a movement device, configured to control a robot to move; a first electronic map, configured to characterize environmental information where the robot is located; a virtual wall module, configured to divide the first electronic map into zones by forming a virtual wall; a storage device, configured to store the first electronic map of the environment where the robot is located.

The virtual wall system for a robot, according to this application, can draw zones on the electronic map provided with the information on the environment where the robot is located, so that the robot travels in a drawn zone, and cannot cross the virtual wall of the drawn zone, which substitutes the functions of a virtual wall generated by hardware. The method for directly drawing a virtual wall on the electronic map facilitates a user to arrange a virtual wall and reduces the cost of manufacturing robots.

Additionally, the virtual wall system for a robot, according to this application, may further be provided with the following additional technical features.

Further, the first electronic map comprises a reference coordinate system and obstacle information.

Further, the different zones of the divided by the virtual wall represent different attributes based on functions.

Further, the first electronic map is generated by the robot automatically, or generated with manual assistance.

Further, the shape of the virtual wall is a geometric shape, including a line, a curve, a circle and a polygon.

Further, the virtual wall is generated by an external apparatus, and transmitted to the robot through communication.

Further, the virtual wall is generated by the robot itself automatically.

Further, the virtual wall is adjusted automatically by the robot according to a practical environment need.

Further, the first electronic map is capable of being updated automatically by the robot based on the environment to form a second electronic map during the movement of the robot.

Further, the automatically updated second electronic map is capable of being matched with the first electronic map based on an algorithm, and being adjusted by referring to a reference system where the first electronic map is located.

Further, the virtual wall is further provided with a time attribute, including an effective time, an invalidation time and a generation time.

Further, different meanings represented by the zones include no admittance, and important zone.

Parts of additional aspects and advantages of this application will be presented in the following description, parts of that will become apparent from the following description or be understood through implementations of this application.

### DESCRIPTION OF THE DRAWING

In order to more clearly illustrate the technical solutions in the embodiments of this application, the drawing to be used in the embodiments will be briefly described below. Obviously, the drawing in the following description only shows some embodiments of this application, and other drawings may be obtained based on the drawing for those skilled in the art without any creative work.

FIG. 1 is a graphical interface configured for software operations of virtual wall according to an embodiment of this application.

### DETAIL DESCRIPTION

The embodiments of this application will be described in detail below, and the examples of the embodiments are illustrated according to the drawing. The same or similar reference numerals are used to indicate the same or similar elements or elements having the same or similar functions throughout the contexts. The embodiments described below with reference to the accompanying drawing are exemplary, and are intended to illustrate this application, and are not to be construed as limitation to this application.

The following will describe a virtual wall system for a robot according to an embodiment of this application with reference to the accompanying drawing.

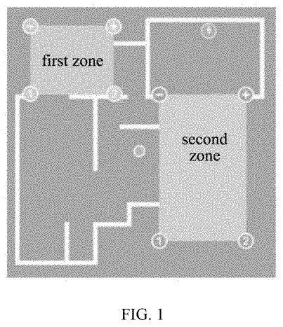

FIG. 1 is a graphical interface configured for software operations of a virtual wall according to an embodiment of this application.

The virtual wall system 100 for a robot, according to an embodiment of this application, is mainly used in the field of cleaning robots, and can generate a graphical interface configured for software operations as shown in FIG. 1. The system 100 includes a movement device, a first electronic map, a virtual wall module, and a storage device.

Specifically, the movement device is configured to control the robot to move. The first electronic map is configured to characterize environmental information where the robot is located. The virtual wall module is configured to divide the first electronic map into zones by forming a virtual wall, as shown in FIG. 1, the virtual wall will be drawn in the first electronic map. The storage device is configured to store the first electronic map of the environment where the robot is located.

The movement device moves according to the first electronic map after the first electronic map is divided by the virtual wall. The storage device stores not only the first electronic map of the environment where the robot is located, but also the first electronic map divided by the virtual wall.

The virtual wall system for a robot, according to this application, can draw zones on the electronic map of the environment in which the robot is located, so that the robot travels in a drawn zone, and cannot cross the virtual wall of the drawn zone, which substitutes the functions of a hardware-type virtual wall. The method for directly drawing a virtual wall on the electronic map facilitates a user to set up a virtual wall and reduces the cost of manufacturing robots. It is especially emphasized that the virtual wall in this application indicates a boundary wall on the electronic map that cannot be acquired through a sensor provided by the robot on its own, and that the virtual wall, having to be acquired through manners such as software calculation or a manual user arrangement or the like, can be referred to as a virtual wall. The boundary wall directly acquired through scanning by the robot may be referred to as a solid wall.

In some embodiments, the first electronic map includes a reference coordinate system and obstacle information, and the first electronic map may be generated by the robot automatically or generated by manual assistance. Specifically, the robot draws the virtual wall on the basis of the map, and the first electronic map may be determined by a simultaneous localization and mapping (SLAM) algorithm implemented through mounting a combination of one or more sensors on a body of the mobile robot such as a laser radar, a depth camera, an infrared ranging sensor, an ultrasonic sensor, an inertial measurement unit (IMU), an odometer, and the like. It is worth noting that, the first electronic map with a software virtual wall may be a partially incomplete map or a complete map with the requirement that there is a determined coordinate system for reference, and there are enough obstacle features on the map. Generally, the obstacle information refers to object information opposite to the virtual wall on the first electronic map, including a physical wall, the physical object, and the like.

In some embodiments, the shape of the virtual wall is a geometric shape including, but not limited to, a straight line, a curve, a circle, a polygon, and the like. Referring to the reference coordinate system of the first electronic map of the robot travelling zones, in order to avoid collision with an obstacle or provide a specific place for the robot to travel, the specific place is circled, and the circle line may have many forms, such as a straight line, a curve, a circle, or a polygon, or a combination of a line, a polygon etc., or the like.

In some embodiments, the virtual wall is generated by an external apparatus, and is transmitted to the robot through communication. For example, the user may perform various operations, such as drawing a line, connecting points into a line, multi-point customization zone and the like, on software applications such as a mobile phone APP, an applet in WeChat Subscription, a web application, a computer application, and the like.

As shown in FIG. 1, a zone may be circled by several vertices on the APP, and the zone may be defined by increasing, decreasing, and dragging a vertex. This method can simplify the operation and is more precise than direct drawing by hands.

Alternatively, the virtual wall may be automatically generated by the robot itself. For example, the virtual wall may be drawn on the first electronic map by the robot itself through a predetermined algorithm.

In some embodiments, the virtual wall may also be intelligently optimized. That is, the virtual wall is automatically adjusted on the robot according to actual environmental requirements.

Specifically, the above process includes: extending the drawn line along the first electronic map to acquire a completely divided linear virtual wall, and/or contracting, expanding, and deforming the drawn zone along an obstacle of the first electronic map to acquire a virtual wall of a zone completely separated from the obstacle. For example, after drawing a line or a zone, due to the reasons such as limited accuracy of the first electronic map, a limited operation mode of the user etc., the user's operation data has difference with an actual desired operation, so a corresponding method is added, which is intended to optimize the line and/or zone drawn by the user, and to intelligently identify the user's operation. If the user draws a line, then a certain method is adopted to extend the virtual wall according to the growth of the map so as to form a completely divided wall. If the user draws a zone, then the zone is automatically contracted, expanded, and deformed according to the obstacles in the zone, so that it is consistent with the distribution of the obstacles on the map.

Referring to FIG. 1 again, the first zone and the second zone are zones drawn by the virtual walls, so that the robot may travel in this zone, and the lines are drawn linear virtual walls, so that the robot may turn around and avoid crossing across when in contact with the linear virtual walls.

In particular, after determining a line and/or a zone drawn by the user, a zone at which side of the virtual wall that the user allows to enter is automatically recognized according to the characteristics of the first electronic map (characteristics such as attribute characteristics of the zone, whether an unknown zone is bordered and distance from the unknown zone, zone of the movable zone, etc.), or a historical movement situation (it may be a historical cleaning situation if the robot is a cleaning robot),or the current location of the robot, and the zone may also be confirmed by assistance from user interaction data.

The virtual wall of a zone is acquired according to the reference coordinate system, the obstacles, the created points of the first map, a preset algorithm, and data interaction from the user. That is to say, the operations for drawing a virtual wall by the user may be various operations such as drawing a line, connecting points into a line, a multi-point customization zone, and drawing a zone by circling etc. on the map, and may also be assisted by an intelligent recognition operation, and may further draw a point. When the user draws a point on the map, a certain zone is selected automatically according to the map as a zone set by the user based on the preset algorithm. In order to prevent a misoperation caused by an error of the algorithm, the user is reminded to interact with the data result and is allowed to further set the zone.

A safe distance between the virtual wall and the obstacle may be set regardless of drawing a line, a zone, or a point.

In some embodiments, the first electronic map is automatically updated by the robot according to the environment during the movement of the robot, so as to form a second electronic map. Furthermore, the automatically updated second electronic map may be matched with the first electronic map through an algorithm and may be adjusted according to the reference system where the first electronic map is located.

Specifically, since the environment where the mobile robot is located will change as the time goes by, and there is an error of the SLAM algorithm, the first electronic map may skew, rotate, deform, etc., and at this time the data from the user interaction will not correspond to previous data. In order to cope with the above change, the data from the user interaction (i.e., the virtual wall) may be corrected by sub-image match, so that the user's operation data (i.e., the virtual wall) is still in the vicinity of the obstacle previously set. First, the second electronic map may be acquired through the above positioning method for acquiring the first electronic map, and the sub-image match refers to matching the zones near the virtual wall in the first electronic map with the new map (i.e., the second electronic map), and calculating new positions of the zones in the second electronic map. Then, the match between the previous virtual wall and the second electronic map is optimized, so as to generate a virtual wall matching the second electronic map.

In some embodiments, the virtual wall further includes a time attribute. The time attribute includes effective time, invalidation time, and generation time. For example, a certain zone is set to be not accessible during the morning time, that is, the effective time is in the morning, the invalidation time is in the afternoon, and the generation time is the time for drawing the virtual wall. From the generation time on, the invalidation time and effective time may be specified. When the time for drawing the virtual wall is at 8:00 am, and it takes effect after 4 hours, and the continual effective time is 2 hours, that is, the virtual wall takes effect from 12 o'clock, the continual effective time is 2 hours, and the expiration time is after 2 pm.

In some embodiments, the different zones of the first electronic map divided by of the virtual wall are provided with different attributes according to functions. Among them, the zones may represent different meanings, which includes, but not limited to, no entry, an important zone, and so on. The first electronic map records information on obstacle locations in the environment, a zone where the robot can move without obstacles, and an unknown zone which is not explored by the robot. For example, in a certain zone, an operation such as patrolling or cleaning or the like is performed in a certain time of the afternoon. When the set corresponding zone corresponds to the time period, the virtual wall is in effect, and the mobile robot is able to perform patrol or cleaning in this zone.

Moreover, the terms “first” and “second” are used for descriptive purposes only and can not be construed as indicating or implying a relative importance or implicitly indicating the number of technical features indicated. Thus, a feature defined with “first” or “second” may include at least one feature, either explicitly or implicitly.

In this application, the terms “installation”, “be connected with”, “be connected to”, “be fixed to” and the like shall be understood broadly, unless otherwise clearly specified and limited. For example, the connection may be either a fixed connection or a detachable connection, or integrally formed; the connection may be a mechanical connection or an electrical connection; the connection may be a direct connection, or an indirectly connection through an intermediate medium, or may be internal communication of two elements or interaction between two elements, unless otherwise clearly defined. For those skilled in the art, the specific meanings of the above terms in this application may be understood on a case-by-case basis.

In the description of the present specification, the description with reference to the terms, such as “one embodiment”, “some embodiments”, “example”, “specific example”, or “some examples” and the like, means that a specific feature, structure, material or feature described in connection with the embodiment or example is included in at least one embodiment or example of the application. In the present specification, a schematic representation of the above terms is not necessarily directed to the same embodiment or example. Furthermore, the particular feature, structure, material, or characteristic described may be combined in a suitable manner in any one or more embodiments or examples. In addition, the various embodiments or examples described in the specification, as well as the features in the various embodiments or examples, may be combined and integrated.

Although the embodiments of this application have been shown and described above, it shall be understood that the above-described embodiments are illustrative and are not to be construed as limitation to this application. Those of ordinary skill in the art may change, modify, substitute and vary the above embodiments within the scope of this application.

1. A virtual wall system for a robot, comprising:
a movement device, configured to control a robot to move;
a virtual wall module, configured to divide a first electronic map into zones by forming a virtual wall, wherein the first electronic map is configured to characterize environmental information where the robot is located;
a storage device, configured to store the first electronic map of the environment where the robot is located.

2. The virtual wall system for a robot according to claim 1, wherein the first electronic map comprises a reference coordinate system and obstacle information.

3. The virtual wall system for a robot according to claim 1, wherein the different zones of the first electronic map divided by the virtual wall represent different attributes based on functions.

4. The virtual wall system for a robot according to claims 1, wherein the first electronic map is generated by the robot automatically, or generated with manual assistance.

5. The virtual wall system for a robot according to claim 1, wherein the movement device is configured to control the robot to move according to the first electronic map divided by the virtual wall.

6. The virtual wall system for a robot according to claim 5, wherein the movement device is configured to control the robot to travel in the divided zones.

7. The virtual wall system for a robot according to claim 1, wherein the virtual wall is generated by an external apparatus, and transmitted to the robot through communication.

8. The virtual wall system for a robot according to claim 1, wherein the shape of the virtual wall is a geometric shape, and the geometric shape is generated through operating, by a finger of a user, a touch screen of a mobile device, when the mobile device displays a display interface.

9. The virtual wall system for a robot according to claim 1, wherein the virtual wall is generated by the robot itself automatically.

10. The virtual wall system for a robot according to claim 9, wherein the virtual wall is generated, by the robot itself, through automatically drawing on the first electronic map based on a predetermined algorithm.

11. The virtual wall system for a robot according to claim 1, wherein the virtual wall is adjusted automatically by the robot according to a requirement of practical environment.

12. The virtual wall system for a robot according to claim 1, wherein the first electronic map is capable of being updated automatically by the robot based on the environment to form a second electronic map during the movement of the robot.

13. The virtual wall system for a robot according to claim 12, wherein the automatically updated second electronic map is capable of being matched with the first electronic map based on an algorithm, and being adjusted by referring to a reference system where the first electronic map is located.

14. The virtual wall system for a robot according to claim 1, wherein the virtual wall is further provided with a time attribute.

15. The virtual wall system for a robot according to claim 14, wherein the time attribute comprises an effective time, an invalidation time and a generation time.

16. The virtual wall system for a robot according to claim 1, wherein the virtual wall is a boundary wall on the first electronic map not able to be acquired through a sensor provided by the robot, and the virtual wall, is acquired through one of the following manners:
calculating through software, and
manually arranging by a user.

17. The virtual wall system for a robot according to claim 1, wherein the zone are automatically contracted, expanded, and deformed according to obstacle distribution in the zone, such that the zones are separated from an obstacle.

18. The virtual wall system for a robot according to claim 3, wherein the different attributes comprises at least one of the following:
no admittance, and an important zone.

19. The virtual wall system for a robot according to claim 7, wherein the zone is circled by several vertices, and the zone is able to be further defined by increasing, decreasing, and dragging a vertex.

20. The virtual wall system for a robot according to claim 8, wherein the geometric shape comprises at least one of the following:
a line, a curve, a circle, and a polygon.
